(19) United States
(12) Patent Application Publication
(10) Pub. No.: US 2009/0038207 A1
(43) Pub. Date: Feb. 12, 2009

(54) Mosquito-killing LED lamp

(75) Inventor: Heng-Yuan Lin, Taipei (TW)

Correspondence Address: BIRCH STEWART KOLASCH & BIRCH, PO BOX 747, FALLS CHURCH, VA, 22040-0747, US

(73) Assignee: WELL ELECTRONICS CO., LTD.

(21) Appl. No.: 11/882,860

(22) Filed: Aug. 6, 2007

(51) Int. Cl. A01M 1/04; A01M 1/22

(52) U.S. Cl. 43/112; 43/113

(57) ABSTRACT

A mosquito-killing LED lamp also serving as a lighting fixture includes an LED light source, one or a plurality of light board comprised of multiple UV LEDs and multiple visible light LED arranged in array; a power supply combined in modular with the LED light source to output power to drive those UV and visible light LEDs; and a casing containing the light board, one or a plurality of electric shock mesh holding against the light board, and one or a plurality of barrier on a surface of the casing; the power supply being electrically connected to one or a plurality of high voltage transformer, which in turn being electrically connected to the electric shock mesh to seduce and killing mosquitoes.

### FIELD OF THE INVENTION

The present invention is related to a mosquito-killing LED lamp, and more particularly, to one that provides lighting function for a mosquito-killing lamp.

### BACKGROUND OF THE INVENTION

Tube type mosquito-killing lamps generally available in the market work on taking advantage of phototaxis of bugs. A mosquito-killing lamp contains multiple tubes to emit UVA that attract bugs; and a high-voltage electric shock mesh is disposed at where closer to those tubes to kill the approaching bugs.

However, only erected tube can be adapted to the mosquito-killing lamp of the prior art and the lamp is almost design in a column style; light emission by tungsten filaments inside the tube not only consume comparatively higher power but also emit UVB and UVC that are hazardous to human health; and though the tube may serve lighting purpose during night hours the basic function of trap to kill will also fail once the tube is out of order.

### SUMMARY OF THE INVENTION

The primary purpose of the present invention is to provide a mosquito-killing LED lamp that is a lighting fixture and a mosquito-killing lamp at the same time to be adapted to any occasion where a moth- or a mosquito-killing lamp is designed.

To achieve the purpose, the present invention includes an LED light source related to one or a plurality of light board comprised of multiple UV LEDs and visible light LEDs arranged in array; a power supply combined in module with the LED light source to output power for driving and controlling those UV LEDs and visible light LEDs; and a casing to receive the light board and one or a plurality of electric shock mesh with the mesh holding against the light board and one or a plurality of barriers disposed on a surface of the casing.

The power supply is electrically connected to one or a plurality of high voltage transformer, which in turn is electrically connected to the electric shock mesh.

The power supply may control those UV LEDs and visible light LEDs in the LED light source respectively or at the same time. Those visible light LEDs significantly upgrade lighting effects and those UV LEDs deliver higher power consumption benefits; therefore, the power supply generates power to drive and control light distribution of the LED source arranged in array to completely eliminate UVB and UVC wavebands that are hazardous to human body for the mosquito-killing LED lamp to provide optimal protection mechanism of human health. The present invention employs high voltage transformer technology to kill mosquitoes on one hand and combines the power supply and the LED light source in a module to facilitate design of an attractive appearance and style of the casing, product assembly and mass production on the other hand.

Accordingly, the LED light source arranged in array of the present invention is particularly helpful for the mosquito-killing LED lamp to provide dual purposes of killing mosquitoes and functioning as a lighting fixture.

### BRIEF DESCRIPTION OF THE DRAWINGS

FIG. 1 is a schematic view showing a preferred embodiment of the present invention as assembled.

FIG. 2 is an exploded view of the preferred embodiment of the present invention.

FIG. 3 is a schematic view showing an operating status of the preferred embodiment of the present invention.

FIG. 4 a schematic view showing another preferred embodiment of the present invention as assembled.

FIG. 5 is a schematic view showing an operating status of the second preferred embodiment of the present invention as illustrated in FIG. 4.

### DETAILED DESCRIPTION OF THE PREFERRED EMBODIMENTS

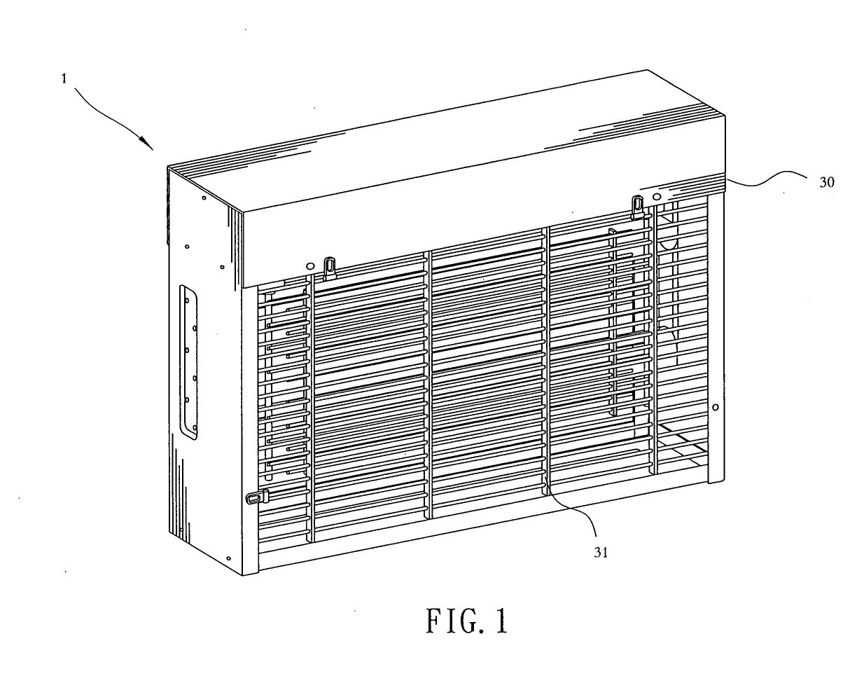

Referring to FIG. 1, a preferred embodiment of the present invention is comprised of a box casing (30), a barrier (31) is disposed to a front surface of a mosquito-killing LED lamp (1) and another identical barrier (not illustrated) is disposed on a back of the mosquito-killing LED lamp (1).

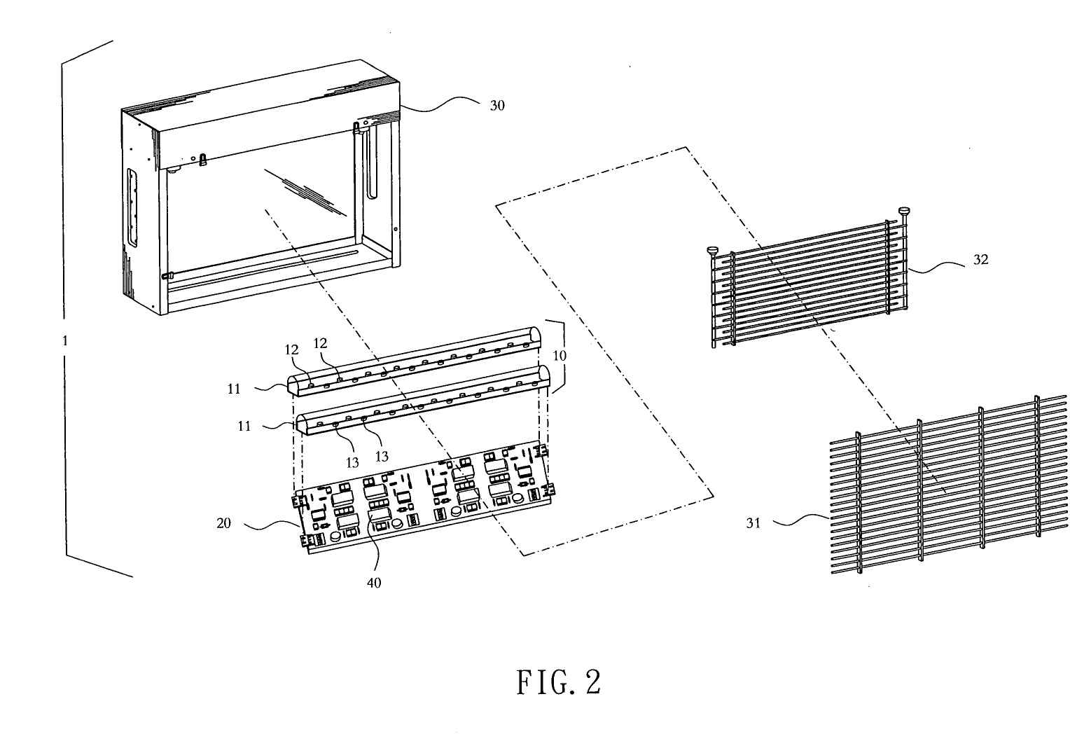

Now referring to FIG. 2 for an exploded view of the preferred embodiment, the mosquito-killing LED lamp (1) is comprised of an LED light source (10), a power supply (20), and the casing (30).

The LED light source (10) relates to one or a plurality of light board (11) with multiple UV LEDs (12) and multiple visible light LEDs (13) arranged in array thereon. Wherein, those UV LEDs (12) arranged in array are capable of expanding coverage of seducing and killing mosquitoes, and completely eliminating emissions of UVB and UVC wavebands that are hazardous to human heath to substitute conventional UV tubes to provide even higher power consumption benefits; and those visible light LEDs (13) significantly upgrade lighting effects of the mosquito-killing LED lamp (1). In case of failure of any of those UV LEDs (12) or those visible light LEDs (13), it takes only to replace the failed one to maintain normal operation of the mosquito-killing LED lamp (1).

The power supply (20) is related to a PCB provided with circuitry and associate electronic devices; a design of having both protruded ends of the power supply allow locating the light board (11) to combine the power supply (20) and the LED light source (10) in module. The highest temperature rise of the modular combination is lower than 30° C. to provide flexibilities in design of the appearance and style of the casing (30) and help product assembly and mass production of the mosquito-killing LED lamp (10). The power supply (20) is related to a static current installation provided with two units of power output with one unit to drive and control those UV LEDs (12) and another unit to drive and control those visible light LEDs (13). Both units of output can be turned on or off simultaneously or only either unit is independently operated. Even those visible light LEDs (13) fail, those UV LEDs (12) remain serving the basic function of lighting. For the preferred embodiment, its maximal power output is 15 W with efficiency greater than 85%, power factor greater than 0.95, and total harmonic loss less than 20%.

The casing (30) receives the light board (11) and has one or a plurality of electric shock mesh (32) is disposed by the light board (11) for the electric shock mesh (32) to hold against the light board (11) while maintaining a small gap. One or a plurality of barrier (31) is disposed to the front surface of the casing (30) to prevent injuries due to accidental contact of the electric shock mesh (32); and another barrier (not illustrated) is disposed to a rear surface of the casing (30).

The preferred embodiment of the mosquito-killing LED lamp (1) has total power consumption less than 18 W; however, it may be expanded up to 80 W if and when applicable.

The preferred embodiment of the mosquito-killing LED lamp (1) has an effective catching coverage between 45 m²˜200 m².

When a power of those UV LEDs (12) is designated at 10 W, their wavebands of light emission are falling between 350 nm˜380 nm.

When a power of those visible light LEDs (13) is designated at 5 W, their wavebands of light emission are falling between 450 nm˜650 nm.

The power supply (20) is electrically connected to one or a plurality of high voltage transformer (40), which in turn is electrically connected to the electric shock mesh (32). In the preferred embodiment, the high voltage transformer (40) is capable of outputting a power up to 4000V to electrify to kill mosquitoes.

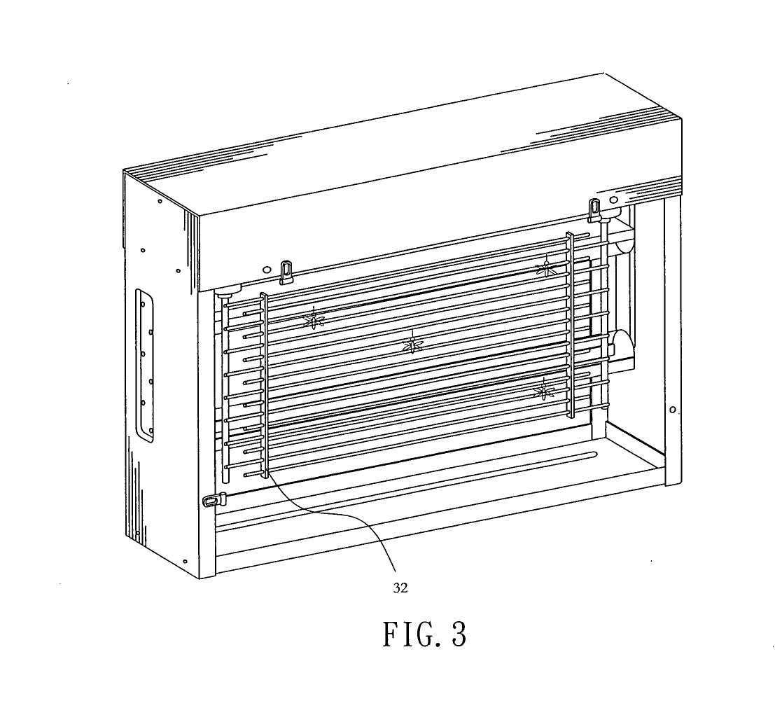

As illustrated in FIG. 3 showing an operating status of the preferred embodiment illustrated in FIG. 1, those UV LED (12) arranged in array emit light in a waveband focusing on 370 nm, the waveband providing the optimal mosquito catching effects; and the phototaxis of the mosquito and its sensitivity to a certain wavelength would cause the mosquito to be electrified and burnt out instantaneously upon contacting the electric shock mesh (32).

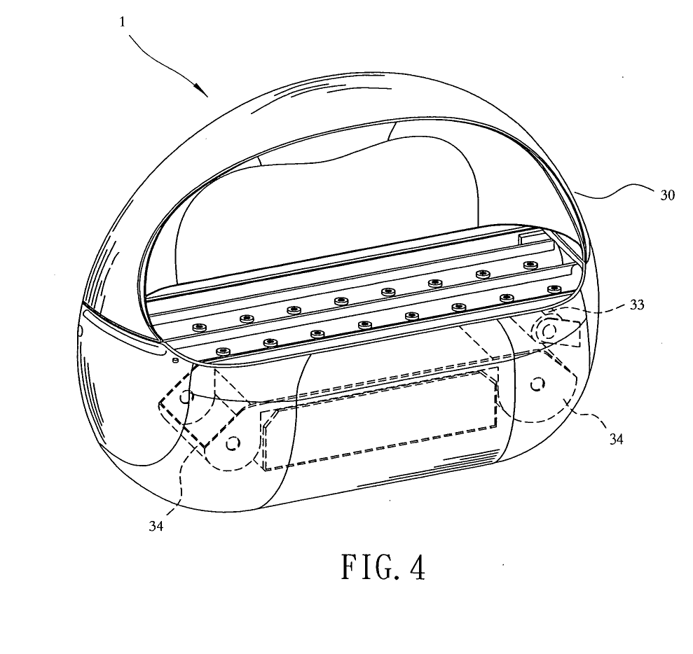

FIG. 4 shows a second preferred embodiment of the present invention. Referring also to FIG. 2 since certain elements of a mosquito-killing LED lamp (1) of the second preferred embodiment are identical with those applied in the first preferred embodiment. As illustrated, the second preferred embodiment is comprised of the LED light source (10), the power supply (20), and the casing (30). Wherein, the LED light source (10) is comprised of one or a plurality of light board (11) provided thereon multiple UV LEDs (12) and multiple visible light LEDs (13) arranged in array to effectively expand killing coverage of the mosquito-killing LED lamp (1) by light distribution among those UV LEDs (12).

The power supply (20) is also combined in module with the LED light source (10) to output power for driving and controlling those UV LEDs (12) and those visible light LEDs (13).

The casing (30) receives the light board (11) and one or a plurality of sticky paper (33); the casing (30) is made in an arc shape; the sticky paper (33) holds against the light board (11) and applied on its surface a sticky substance (not illustrated) to facilitate catching mosquitoes; and a fragrant (not illustrated) helping seducing the mosquitoes is added into the sticky substance as applicable.

One or a plurality of roll holder (34) is disposed in the casing (30); and a roll (not illustrated) is placed in the roll holder (34) to wind up a portion of the stick paper (33) that is already covered up by mosquitoes.

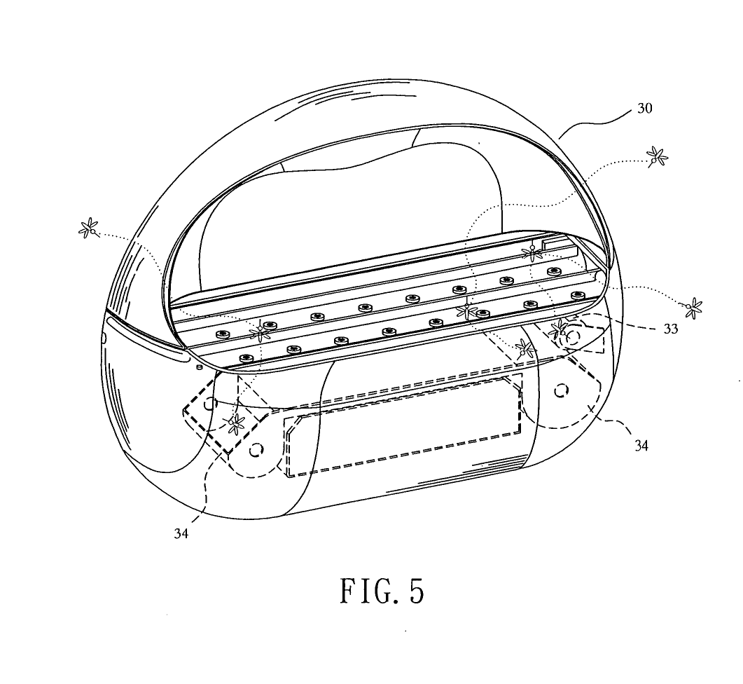

Finally as illustrated in FIG. 5 showing a schematic view of an operating status taken from FIG. 4, wherein the dotted line indicates a flying route of each individual mosquito that ends up in the casing (30) and terminates on a surface of the sticky paper (33) for mosquitoes to be attracted and caught on the sticky paper (33).

The prevent invention provides a mosquito-killing LED lamp having a more attractive appearance and style, better attract to kill coverage, and night lighting effects to favor substantial development of a moth- or a mosquito-killing lamp to deliver extremely high value of industrial utility; and there is not yet any appearance or use in public disclosed or published in the market of anything that is similar to or identical with the prevent invention for the present invention to meet active or passive elements of a patent as defined in the patent law; therefore the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A mosquito-killing LED lamp comprising:
an LED light source related to one or a plurality of light board comprised of multiple UV LEDs and visible light LEDs arranged in array;
a power supply combined in module with the LED light source to output power for driving and controlling those UV and visible light LEDs; and
a casing to receive the light board and one or a plurality of electric shock mesh, the electric shock mesh holding against the light board, and one or a plurality of barrier being disposed on a surface of the casing.

2. The mosquito-killing LED lamp as claimed in claim 1, wherein the mosquito-killing LED lamp has total power consumption not greater than 18 W and a maximal total power consumption expansion up to 80 W.

3. The mosquito-killing LED lamp as claimed in claim 1, wherein the mosquito-killing LED lamp has an effective killing range between 45 m²˜200 m².

4. The mosquito-killing LED lamp as claimed in claim 1, wherein the UV LED has a power of 10 W/hour and a light emitting waveband between 350 nm˜380 nm.

5. The mosquito-killing LED lamp as claimed in claim 1, wherein the visible light LED has a power of 5 W/hour and a light emitting waveband between 450 nm˜650 nm.

6. The mosquito-killing LED lamp as claimed in claim 1, wherein the power supply is electrically connected to one or a plurality of high voltage transformer; and the high voltage transformer is further electrically connected to the electric shock mesh.

7. The mosquito-killing LED lamp as claimed in claim 6, wherein the high voltage transformer is capable of outputting a power up to 4000V.

8. The mosquito-killing LED lamp as claimed in claim 1, wherein the casing is sufficient to receive the light board and one or a plurality of sticky paper; the casing has an arc shape; and the sticky paper rests on the light board.

9. The mosquito-killing LED lamp as claimed in claim 8, wherein the sticky paper is provided on its surface a sticky substance, and fragrance that attract mosquitoes is added into the sticky substance as applicable.

10. The mosquito-killing LED lamp as claimed in claim 8, wherein one or a plurality of roll holder is disposed in the casing to accommodate a roll for winding up the sticky paper already covered up with mosquitoes caught.
